(19) United States
(12) Patent Application Publication
(10) Pub. No.: US 2026/0043406 A1
(43) Pub. Date: Feb. 12, 2026

(54) PUMPING DEVICE FOR A MOTOR VEHICLE

(71) Applicant: MAHLE International GmbH, Stuttgart (DE)

(72) Inventors: Holger Conrad, Veilsdorf (DE); Alfred Elsaesser, Keltern (DE); Michael Langer, Bad Rodach (DE); Lukas Schmidt, Leinatal (DE); Michael Sahr, Eisfeld (DE); Dieter Hoehn, Hildburghausen (DE); Marco Kirchner, Auengrund (DE); Tiemo Ehlers, Coburg (DE); Herwig Moser, Forchheim (DE)

(21) Appl. No.: 19/100,560

(22) PCT Filed: Jul. 31, 2023
(86) PCT No.: PCT/EP2023/071158

§ 371 Date: Jan. 31, 2025

(30) Foreign Application Priority Data
Aug. 1, 2022 (DE) 10 2022 207 938.8

(51) Int. Cl. F04D 13/06; F01P 5/12; F04D 15/00; H01M 8/04029; H01M 8/0432; H01M 8/04746

(52) U.S. Cl. CPC F04D 13/06; F04D 15/0088; H01M 8/04029; H01M 8/04358; H01M 8/04768; F01P 5/12; F01P 2005/125; H01M 2250/20

(57) ABSTRACT

A pump device for a motor vehicle, e.g., for a cooling device of a fuel cell system and for pumping cooling fluid, is disclosed. The pump device includes a housing, in which a fluid channel is arranged through which a cooling fluid to be conveyed can flow. A drive unit for driving the cooling fluid guided through the fluid channel. An electric sensor unit that includes at least one sensor for determining at least one measured variable characterizing the cooling fluid. The sensor unit is arranged at least partially in the fluid channel, and/or the at least one sensor of the sensor unit is a temperature sensor that is arranged outside the fluid channel and is coupled in a heat-conducting manner to the fluid channel.

### CROSS-REFERENCE TO RELATED APPLICATIONS

This application claims priority to International Patent Application No. PCT/EP2023/071158 filed Jul. 31, 2023, which also claims priority to Germany Patent Application DE 102022207938.8 filed Aug. 1, 2022, the contents of each of which is hereby incorporated by reference in its entirety.

### TECHNICAL FIELD

The invention relates to a pump device, such as an oil pump, a water pump, or similar, for a motor vehicle or for a cooling system of a motor vehicle, in particular a fuel cell system, and for pumping cooling fluid, in particular oil, water or cooling water, or similar. The invention relates to such a motor vehicle, such a cooling device, and a motor vehicle with such a cooling device and/or with a fuel cell system. Such pump devices may be of various types, for example, a centrifugal pump, a gerotor pump, a rotary vane pump, or the like. Finally, the invention also relates to a method for determining a measured variable, in particular a fluid temperature, which characterizes a cooling fluid in a pump device according to the invention.

### BACKGROUND

With the help of cooling fluid, components of a motor vehicle that generate waste heat, for example its drive train, in particular a fuel cell system, can be cooled by the cooling fluid absorbing and dissipating the waste heat that is produced. Similarly, the cooling fluid can also be used to cool electrical or electronic components of the vehicle that generate waste heat.

In both cases, the cooling fluid is typically circulated in a cooling circuit. Typically, a pump device is used to drive or convey the coolant in the cooling circuit. To ensure that they function properly, it is important to know various parameters and measured variables as accurately as possible, such as the fluid temperature of the pumped cooling fluid, the fluid pressure of the pumped cooling fluid, the mass flow rate pumped and thus the pumping capacity of the pump device, and/or the electrical conductivity of the cooling fluid. Suitable sensors may be provided in the cooling circuit for this purpose.

Such sensors are usually placed in contact with the cooling fluid along the cooling circuit. For example, DE102009005154A1 discloses a pump device with various sensors for measuring quantities. DE1983928U discloses a pump device with a temperature sensor arranged in the cooling fluid in the pump device.

However, the electrical implementation of said sensors in the cooling circuit, in particular their electrical wiring for control and electrical power supply, proves to be very complex and thus cost-intensive. Furthermore, it has proven to be costly and time-consuming to ensure reliable measurement of the respective variable while also protecting electrical components from the cooling fluid.

US 2015/093253 A1 discloses a pump device for freshwater module systems and a method for detecting the temperature of a fluid conveyed by the pump device by measuring thermal radiation using a temperature sensor. The fluid temperature of the pumped medium is determined on the basis of the recorded heat radiation by means of an externally performed calculation. The method requires the temperature sensor to be located outside the cooling fluid. However, this method and the arrangement required for it are also complex and may be unsuitable for motor vehicle applications, as special conditions apply to motor vehicle applications in terms of accuracy, robustness, and reliability. It is often necessary to determine the temperature of a cooling liquid quickly and reliably. For example, it may be necessary to detect a change in the temperature of the cooling fluid of 50 K within a maximum of 30 seconds, in particular a maximum of 15 seconds, in particular a maximum of 7 seconds.

It is therefore an object of the present invention to provide an improved embodiment of a known pump device in which at least one of the said disadvantages is partially or even completely eliminated. In particular, one purpose of the present invention is to provide a pump device that is compact and robust and at the same time enables reliable detection of at least one of the measured variables, in particular the temperature of the cooling fluid.

This object is achieved by the scope of the independent claim(s). Preferred embodiments are the scope of the dependent claims.

### SUMMARY

One of the basic ideas of the invention is therefore to equip a pump device for a motor vehicle, which can be arranged in a cooling circuit for circulating cooling fluid, with a sensor unit having at least one sensor, in particular having at least two sensors, for determining one or more measured variables characterizing the cooling fluid, in particular for determining two measured variables characterizing the cooling fluid. Since the cooling fluid to be circulated in the cooling circuit must be guided through a fluid channel provided in the pump device in order to be conveyed, it is proposed to integrate said sensor unit directly into the pump device. This saves on installation space. Furthermore, it is possible to use electrical components that are already installed in the pump device for the electrical control and power supply of the sensor unit, such as a printed circuit board with electrical/electronic components or a printed circuit board assembly (PCBA). In this way, an electrical power supply for supplying the electrical drive unit and/or other electrical/electronic components, in particular a control/regulating device, of the pump device with electrical energy can be used at the same time to supply the sensor unit with electrical energy. Furthermore, a control/regulating device for controlling the electric drive unit can be used at the same time to control the sensor unit and/or to process the respective measured variable detected by the sensor unit. This makes it possible to significantly simplify the structure of the pump device. As a result, considerable cost advantages are achieved. The pump device according to the invention may also be suitable for applications whose subject matter is not, or at least not predominantly, the cooling of components that generate waste heat. The cooling fluid can thus also be understood as a fluid or liquid in general.

In detail, the pump device according to the invention for conveying cooling fluid, in particular water, oil, cooling water, or the like, comprises a housing in which a fluid channel is arranged through which the cooling fluid to be conveyed can flow. The fluid channel can be designed, for example, as a water channel for water or cooling water as a cooling fluid or as an oil channel for oil as a cooling fluid. In addition, the pump device comprises a drive unit for driving the cooling fluid that is guided through the fluid channel.

Furthermore, the pump device includes an electric sensor unit which includes at least one sensor for determining at least one measured variable characterizing the cooling fluid, in particular a thermodynamic measured variable, such as, for example, a fluid temperature.

According to a first aspect of the invention, the sensor unit is arranged at least partially in the fluid channel. In a favorable embodiment, the sensor unit with the at least one sensor extends into the fluid channel. This allows a quick and relatively direct detection of changes in the characteristic properties of the cooling fluid.

According to a second aspect of the invention, the at least one sensor of the sensor unit is arranged outside the fluid channel, either in addition to or as an alternative to the arrangement according to the first aspect of the invention. The sensor is coupled to the fluid channel in a heat-conducting manner. In particular, the sensor is coupled to one fluid channel wall of the fluid channel in a heat-conducting manner. The fluid channel wall delimits a space in the fluid channel through which the cooling fluid can flow in the region of the sensor.

Generally, the at least one sensor is designed as a temperature sensor. This means that the sensor can be used to determine the temperature of the cooling liquid flowing through the liquid channel. The temperature sensor, when coupled to the fluid channel in a heat-conducting manner, is heated by the fluid temperature through the coupling in a heat-conducting manner. The fluid channel wall can, in particular predominantly, be made of metal. The fluid channel wall may contain metal and/or metal oxide such as zinc oxide, silicon carbide, or the like. The fluid channel wall is preferably made of stainless steel.

Preferably, the fluid channel wall is nonmagnetic or has only paramagnetic or diamagnetic properties. The fluid channel wall is preferably made of stainless steel. The fluid channel wall may be made of plastic with a filler to ensure good thermal conductivity. Possible fillers include, for example, metal/metal oxide or the materials mentioned above. Since materials containing metal have good thermal conductivity, heat transfer from the cooling fluid to the fluid channel wall and heat transfer from the fluid channel wall to the temperature sensor can be improved.

This coupling by means of heat conduction has proven to be particularly effective compared to other types of heat transfer, such as heat radiation or convection, in ensuring a fast and accurate determination of the fluid temperature while at the same time making the pump device robust. In addition to heat conduction, other heat transfer mechanisms can contribute slightly to heat transfer between the cooling fluid and the temperature sensor. However, these are negligible for the heat transfer from the fluid channel wall to the temperature sensor.

In preferred embodiments, the sensor and a fluid channel wall of the fluid channel are spaced apart by less than 10 mm, in particular by less than 5 mm, in particular by less than 3 mm, in particular by less than 0.5 mm, in particular by less than 0.35 mm. When the sensor is placed as close as possible to the fluid channel, good heat conduction is ensured.

Preferably, the entire sensor unit is arranged in the housing of the pump device outside the fluid channel, whereby the sensor unit is better protected.

According to a favorable embodiment, the fluid channel wall has an external recess in which the sensor, in particular the sensor unit, is at least partially arranged. The sensor unit should preferably be at least 50% embedded in the recess, and in particular at least 70%, and in particular should be fully embedded in the recess. In particular, the recess has a depth of at least 2 mm, in particular 3 mm to 5 mm, in particular a maximum of 7 mm, in particular a maximum of 4 mm. The external recess can be designed as an embossing of the fluid channel wall in the direction of its inner side, in particular deep-drawn. To improve heat transfer, the sensor or sensor unit is pressed against the fluid channel wall in the recess, which is particularly advantageous. With the deepening, the fluid channel wall can have a corresponding inner projection. The inside of the fluid channel wall is the side of the fluid channel wall that delimits the space of the fluid channel through which the cooling fluid can flow. Generally preferred, the fluid channel wall is integrally formed, particularly as a sheet metal or injection molded component.

The sensor can be arranged outside the fluid channel and still enable a good determination of the fluid temperature, due to the best possible heat-conducting coupling of the sensor and the fluid channel or its fluid channel wall. An arrangement outside the fluid channel in the housing of the pump device not only provides better protection for the sensors but also allows for easier connection to other electrical/electronic components of the pump device, such as a control/regulating device.

The invention also includes advantageous embodiments in which the sensor unit as a whole has the features mentioned above for the sensor or temperature sensor with regard to its arrangement relative to or its interaction with the fluid channel.

The heat-conducting coupling can be improved by the sensor and the fluid channel, in particular the fluid channel wall, being connected in a heat-conducting manner by a heat-conducting layer, in particular a heat-conducting paste and/or a gap filler and/or a heat-conducting pad.

The fluid channel preferably has two channel regions arranged one after the other along a flow path of the cooling fluid in the fluid channel. The flow path describes the path of a fluid particle of the cooling fluid through the fluid channel via a location in the fluid channel that is closest to the sensor unit. One of the channel regions is designed to guide cooling fluid towards the sensor unit and another of the channel regions is designed to guide cooling fluid towards the sensor unit away from the sensor unit. When the pump device is operated, cooling fluid is pumped through both channel regions in succession. Generally, the fluid channel regions are aligned in such a way that the cooling fluid coming from one of the fluid channel regions flows against the fluid channel wall before entering the other fluid channel region. The fluid channel wall is designed to preferentially redirect cooling fluid from one of the channel regions to enter the other of the channel regions, which improves the flow. The fluid channel is designed such that the cooling fluid is diverted along the flow path at the level of the sensor unit or the at least one sensor, in particular by at least 30°, in particular by at least 90°, in particular by at least 120°, in particular by less than 160°, with respect to a respective alignment of the flow path directly before and after the deflection, which, during the operation of the pump device in the deflection region, produces favorable flow conditions for the heat transfer. Preferably, the fluid channel provides a flow path for cooling fluid from one of the channel regions against the fluid channel wall and from the fluid channel wall through the other of the channel regions. A preferably continuous flow improves the heat transfer from cooling fluid to fluid channel or fluid channel wall, so that fluid temperature changes of the cooling fluid can be easily detected.

In a preferred embodiment of the pump device according to the invention, the drive unit of the pump device comprises a rotatable drive shaft on which a pump rotor for conveying the cooling fluid in the fluid channel is arranged in a rotationally fixed manner. Depending on the type of pump, the pump rotor may be designed, for example, as an impeller, gear wheel, gerotor, eccentric or eccentric screw, rotary valve, or similar. Furthermore, the pump device comprises an electric machine with a stator and a rotor for driving the drive shaft. The stator is fixed to the housing, while the rotor is connected to the drive shaft in a rotationally fixed manner, so that a relative rotational movement can take place between the rotor and the stator. The rotor is preferably permanently magnetized. The drive shaft can be rotatably mounted on the housing or another component of the pump device that is fixed in relation to the housing by means of suitable bearing elements.

According to a generally preferred embodiment, the pump device comprises a wet region and a dry region that is sealed in a fluid-tight manner to the wet region. This prevents liquid, especially the cooling fluid, from entering the dry region from the wet region. The rotor of the electric machine is located in the wet region and the stator of the electric machine is located in the dry region. These so-called wet-runners are known to those skilled in the art. The fluid channel runs through the wet region of the pump device. Additional components required to pump the cooling fluid can be arranged in the wet region. The temperature sensor, which is arranged outside the fluid channel and coupled to the fluid channel in a heat-conducting manner, is arranged in the dry region.

The preferred pump device has a containment shell that separates the dry region and wet region in a fluid-tight manner. The fluid channel wall is preferably formed at least in sections by the containment shell. The containment shell is usually made of metal, wherein non-magnetic materials are preferred to avoid adverse interactions with permanent and/or electromagnetic components.

In a generally preferred configuration, the fluid channel extends in sections in the axial direction in a region radially between the stator and the rotor, in each case relative to an axis of rotation of the rotor. In particular, the drive shaft and/or the rotor of the electric machine each delimit at least one channel region. This means that the pump device is particularly well integrated and the cooling fluid can also be used to cool rotating parts of the pump device.

This can be further improved by running one of the channel regions between the rotor and stator and/or running the other channel region through the rotor.

Furthermore, in an advantageous embodiment, the drive unit includes a control/regulating device for controlling the electric machine with stator and rotor. The control/regulating device is preferably located in the dry region of the pump device. The control/regulating device includes an electrical circuit board on which at least one electrical/electronic component is arranged. These components may include, for example, sensors, capacitors, coils, resistors, switches (in particular semiconductor switches), and integrated circuits. Furthermore, in this embodiment, the sensor unit is electrically connected to the printed circuit board. In this way, the sensor unit can be controlled directly via the printed circuit board or with the help of the electrical/electronic components arranged on the printed circuit board. This means that a separate electrical wiring of the sensor unit to the outside is not necessary; in fact, the complete electrical control of the sensor unit can be carried out via the aforementioned printed circuit board.

According to a favorable further development, the sensor unit can also be arranged on the printed circuit board. The sensor unit can therefore be designed as an SMD component, for example. The sensor unit and printed circuit board are then part of a printed circuit board assembly (PCBA). This means that the sensor unit can be pre-assembled directly on the printed circuit board during the manufacture of the pump device. Furthermore, this new technology makes it possible to eliminate the provision of electrical connecting lines between the printed circuit board and the sensor unit, which results in both space and cost advantages.

To ensure good heat conduction, the printed circuit board should preferably be connected to the fluid channel wall by means of the heat-conducting layer, in particular directly and in a heat-conducting manner. Generally, the fluid channel wall, heat conducting layer, and printed circuit board are stacked on top of each other.

It is generally preferred that electrical components of a printed circuit board assembly be arranged at least predominantly on one side of the printed circuit board in order to simplify production. Preferably, therefore, the at least one sensor, in particular the sensor unit, is arranged on the side of the printed circuit board facing away from the fluid channel. This allows for a space-saving design and a simpler layout of the circuit board assembly.

Preferably more than 50%, in particular more than 85%, in particular all of the electrical/electronic components arranged on the printed circuit board are arranged on the side of the printed circuit board facing away from the fluid channel. By arranging as many components as possible on this one side facing away from the fluid channel, the circuit board can be arranged closer to the fluid channel.

When the pump device is in operation, the circuit board can heat up due to electrical resistance, e.g., from electrical/electronic components and conductor tracks or integrated circuits of the circuit board. The printed circuit board or printed circuit board assembly thus represents a heat source. This self-heating can influence the determination of the measured variable, in particular the fluid temperature. According to an advantageous further development, another temperature sensor is therefore arranged on the printed circuit board for detecting a printed circuit board temperature. The sensor unit and the further temperature sensor are spaced and interact in such a way that, when determining the measured variable characterizing the cooling fluid, an influence of self-heating of the printed circuit board on the measured variable can be taken into account or is taken into account by comparison with the printed circuit board temperature measured by the further temperature sensor.

Advantageously, a heat-conducting coupling of the further temperature sensor to the fluid channel is negligibly small. Preferably, the additional temperature sensor is arranged radially with respect to an axis of rotation of the rotor, without overlapping, next to the fluid channel wall. In particular, the printed circuit board is spaced from the fluid channel wall by a gap at the level of the further temperature sensor. This ensures that the printed circuit board is coupled to the fluid channel in a heat-conducting manner outside the location where the additional temperature sensor is arranged.

The self-heating can be taken into account in advantageous embodiments, in particular additionally, in a different way when evaluating a signal from the sensor of the sensor unit for determining the measured variable. According to a particularly preferred embodiment, a power consumption of the printed circuit board assembly, i.e., of the printed circuit board and the electrical/electronic components arranged thereon, is detected by a controller on the printed circuit board and a correlating differential value is subtracted from the signal of the at least one sensor. If the sensor is designed as a temperature sensor, the power consumption of the printed circuit board assembly can thus be detected by means of a controller and a correlating differential value can be subtracted as a differential temperature from the signal detected by the temperature sensor. This further improves the accuracy of the temperature measurement compared to an arrangement in which the sensor is located directly in the cooling fluid.

According to a further development, the printed circuit board is pressed, in particular directly, against the fluid channel wall of the fluid channel. This improves the heat conduction between the fluid channel and the temperature sensor arranged on the circuit board. In some embodiments, this may eliminate the need for a heat conducting layer.

According to a further development, at least one sensor of the sensor unit is arranged on the side of the printed circuit board facing the fluid channel, which improves the heat-conducting coupling of the sensor and the fluid channel. In addition, this ensures that the sensor or sensor unit can be arranged in the recess of the fluid channel wall, which also contributes to a compact design. In particular, the sensor or sensor unit is pressed against the fluid channel wall.

According to a favorable further development, the sensor unit can be electrically connected to the printed circuit board by means of at least one cutting clamp connection or by means of at least one plug connection. This makes it easier to remove the sensor unit from the printed circuit board if necessary.

In accordance with a favorable development, the control/regulating device can include an electrical power supply for supplying the electric machine with electrical energy. In this further development, the sensor unit for supplying the at least one sensor with electrical energy is electrically connected to this electrical power supply. This eliminates the need for a separate electrical connection of the sensor unit to such a power supply. Rather, the sensor unit can be supplied with electrical energy via the electrical voltage supply of the control/regulating device. This considerably simplifies the electrical wiring of the sensor unit, which also results in noticeable cost advantages.

According to a favorable further development, the control/regulating device includes a communication unit for communicating with an external field bus, in particular with a LIN or CAN bus of a motor vehicle. In this advanced development, the sensor unit for reading or controlling the at least one sensor is connected to the controller and/or the communication unit electrically and/or for data transfer. This enables flexible control and flexible reading of the sensor unit from the outside via the field bus mentioned, without the need for a separate communication unit. Rather, the communication unit of the control/regulating device can also be used to control or read out the sensor unit.

According to a preferred embodiment, the temperature measured by a sensor and a phase current of the electrical machine determined by the control/regulating device, and in particular a speed of the pump rotor, are to be processed by means of a correlation of pressure, temperature, and phase current, and in particular speed, stored in the control/regulating device, in particular to be processed in the control/regulating device in order to calculate a pressure of the cooling fluid. The pump device is particularly adapted to transmit data on the calculated pressure via the control/regulating device, in particular the communication unit for communicating with the external field bus. This means that pressure sensors in the fluid channel can be dispensed with and yet a rough estimate of the pressure prevailing in the pump device can be determined.

In a preferred embodiment, the pump device is designed to process, in particular in the control/regulating device, a temperature measured by the temperature sensor as at least one sensor and a rotational speed of the pump rotor, as well as in particular a phase current of the electrical machine determined by the control/regulating device, by means of a correlation of pressure, temperature, and phase current, as well as in particular rotational speed, stored in the control/regulating device, in particular to process it in the control/regulating device, in order to calculate a mass flow and/or volume flow of the cooling fluid. The pump device is particularly adapted to transmit data on the calculated mass flow or volume flow via the control/regulating device, in particular the communication unit for communicating with an external field bus. This means that mass flow sensors in the fluid channel can be dispensed with and yet the mass flow of the cooling fluid in the fluid channel can be determined at least approximately.

However, the invention also includes embodiments in which pressure or mass/volume flow is measured directly. In a preferred embodiment, the sensor unit can have at least two of the sensors explained below. One such sensor may be a pressure sensor for detecting the fluid pressure of the cooling fluid passing through the fluid channel. This makes it possible to determine exactly the pressure at which the cooling fluid is pumped by the pump device. Another sensor of the sensor unit can be a temperature sensor for determining the temperature of the cooling fluid that is passed through the fluid channel. This makes it possible to determine the temperature of the cooling liquid flowing through the cooling channel very accurately. This is particularly important if the cooling fluid is to absorb waste heat from the components to be cooled. In this embodiment, a further sensor of the sensor unit can be a mass flow sensor for determining the mass flow of cooling fluid through the fluid channel. In this way, the instantaneous flow rate of the cooling fluid pumped by the pump device can be precisely determined. In this embodiment, a further sensor of the sensor unit can comprise an electrical conductivity sensor for determining the electrical conductivity of the cooling fluid conducted through the fluid channel. This also allows the electrical conductivity of the cooling fluid to be determined precisely. Precise knowledge of the cooling fluid's electrical conductivity can prove advantageous if the fluid channel is bounded by metal components, since a cooling fluid with too high an electrical conductivity could then cause an electrical short circuit. However, it is also conceivable to use at least one further sensor to determine another measurement parameter in combination with at least one of the sensors presented above.

According to a favorable further development the sensor unit covers a sensor housing, in and/or at which the at least one sensor is arranged. Furthermore, in this further development, at least one sensor and the sensor housing are designed as a unit, in particular as an SMD unit. This design is particularly compact and can be easily installed in the housing of the pump device, where it saves space.

According to a further advantageous development, the drive shaft is designed as a hollow shaft, preferably hollow-cylindrical, which surrounds a cavity, preferably cylindrical, which forms a part of the fluid channel. The cavity serves as a passage for the cooling fluid. In this further development, the cooling fluid flows through the drive shaft. One of the channel regions running through the hollow shaft to the pump rotor is particularly preferred.

In this further development, the sensor unit is preferably arranged in an axial extension of the cavity in the fluid channel. This ensures a reliable flow in the region of the sensor unit.

In a favorable embodiment, the rotor has an axial passage to the pump rotor. In this design, the cooling channel runs through this passage. The flow path of the cooling fluid can thus pass through the rotor. Preferably, one of the two channel regions extends through the rotor passage to the pump rotor. Preferably, the passage is formed radially between a holding section and a magnet section radially spaced from the holding section. The holding section and magnet section are rigidly connected to each other, in particular by being encapsulated in plastic. The rotor is attached to the drive shaft by means of the holding section. The rotor is designed to be permanently magnetic, at least in the magnet section, in particular in such a way that at least one permanent magnet is arranged in the magnet section. During the further development, the rotor thus forms part of the fluid channel between the magnet section and the holding section. This enables a better integration of the cooling channel and at the same time allows effective cooling of the rotor by means of cooling fluid.

The inventors have determined that a high flow rate of the cooling fluid improves heat transfer to the temperature sensor. To create favorable flow conditions, the pump device can have a delivery geometry along the fluid channel, which allows a higher flow velocity. The delivery geometry works together with the cooling fluid to deliver the cooling fluid. According to one embodiment, at least one conveying geometry is formed in the hollow shaft. When the hollow shaft rotates, the pumping geometry works together with the cooling fluid in such a way that the cooling fluid is pumped through the hollow shaft. Accordingly, the rotor can have at least one conveying geometry in advantageous embodiments, in particular in the passage. When the rotor turns, the pumping geometry works together with the cooling fluid in such a way that the cooling fluid is pumped through the rotor and/or past the rotor. Such flow patterns are also conceivable in other regions, particularly in the first and/or second channel region of the fluid channel.

According to a favorable embodiment, a sealing device is arranged axially between the pump rotor and the rotor for sealing the connection between the rotor and the housing. The sealing device is preferably designed as a labyrinth seal. The sealing device provides a sealing gap between the rotor and the housing. The sealing gap ensures a tight connection while also allowing the rotor to move relative to the housing as intended to drive the drive shaft. For this purpose, the sealing device has a first sealing part that is rigidly, in particular integrally, connected to the rotor, and a second sealing part that is rigidly, in particular integrally, connected to the housing. The sealing gap is formed between the sealing parts. The sealing device is preferably arranged for the flow of cooling fluid past it on both sides of the sealing device in opposite directions. In particular, the sealing device separates the two channel regions from each other. The sealing gap preferably has a maximum gap width of 2 mm, in particular a maximum of 1 mm, and in particular at least 0.2 mm. Since only a negligible amount of cooling fluid can penetrate through the sealing gap, a sufficient seal is guaranteed. In one embodiment, the sealing device is designed to delimit the fluid channel in such a way that cooling fluid directed towards the sensor unit passes the sealing device to reach the pump rotor. In one embodiment, the sealing device is designed to delimit the fluid channel in such a way that cooling fluid is directed past the sealing device towards the sensor unit. This ensures that the cooling fluid flowing through the rotor is reliably directed to the pump rotor without mixing significantly with cooling fluid from other channel regions.

The housing may be designed in a preferred manner such that it is at least in two parts, preferably in three parts, with a main housing body in which the drive unit is arranged, and with at least one, preferably two, housing cover(s). In this variant, at least one housing cover is detachably attached to the housing body, preferably by means of at least one bolted connection. Furthermore, in this variant, the sensor unit, and preferably also the printed circuit board, is firmly attached to a housing cover. This means that the sensor unit can be mounted on the pump device when the housing cover is mounted on the main body of the housing, or the sensor unit can be pre-mounted on the housing cover. This simplifies the assembly of the pump device.

The invention also relates to a cooling system for a fuel cell system of a motor vehicle. The cooling system includes a cooling circuit for circulating cooling fluid, in particular water or cooling water, and a pump device, according to the invention, arranged in the cooling circuit for conveying the cooling fluid in the cooling circuit. The advantages of the pump device according to the invention, as explained above, therefore also apply to the cooling device according to the invention.

The invention also relates to a motor vehicle with a pump device according to the invention, wherein the motor vehicle comprises a drive train with a component generating waste heat, which is thermally coupled to the cooling device so that the generated waste heat can be transferred to the cooling fluid circulating in the cooling circuit. The component generating the waste heat can be, for example, an electric motor, an internal combustion engine, or a fuel cell. The motor vehicle according to the invention may comprise features described above in connection with the pump device according to the invention.

The invention also relates to a motor vehicle with a cooling device according to the invention, as explained above. The advantages of the pump device according to the invention, as explained above, therefore apply to the motor vehicle according to the invention.

According to one embodiment, this includes a waste heat-generating fuel cell system that is thermally coupled to the cooling device so that the waste heat generated can be transferred to the cooling fluid circulating in the cooling circuit.

The invention also relates to a method for determining a measured variable, in particular a thermodynamic measured variable, in particular a fluid temperature, which characterizes a cooling fluid in a pump device according to the invention. In the method, the cooling fluid is guided in a fluid channel towards a sensor unit. Heat or thermal energy is transferred from the cooling fluid directed towards the sensor unit to the sensor unit by flowing into the fluid channel and via a heat-conducting coupling of the fluid channel and sensor unit. A sensor of the sensor unit detects the thermal energy transferred to the sensor unit by measuring the temperature, wherein the sensor unit preferably determines the measured variable. The cooling fluid directed towards the sensor unit is directed away from the sensor unit.

According to a preferred embodiment, the cooling fluid is diverted along a flow path of the cooling fluid at the level of the at least one sensor of the sensor unit, from one channel region of the fluid channel to entry into another channel region of the fluid channel.

The method may have features as described above in connection with the pump device, the motor vehicle, and the cooling device.

Further important features and advantages of the invention can be seen from the sub-claims, from the drawing, and from the associated description of the figures with reference to the drawing.

It is understood that the features mentioned above and those to be explained below can each be used not only in the combination indicated in each case, but also in other combinations or on their own, without departing from the scope of the present invention.

Preferred exemplary embodiments of the invention are shown in the figures and are explained in more detail in the following description, wherein the same reference signs refer to the same or similar or functionally identical components.

### BRIEF DESCRIPTION OF THE DRAWINGS

Shown are

FIG. 1: an example of a pump device according to the first aspect of the invention in a sectional view;

FIG. 2: an exemplary embodiment of a pump device according to the second aspect of the invention in a sectional view.

### DETAILED DESCRIPTION

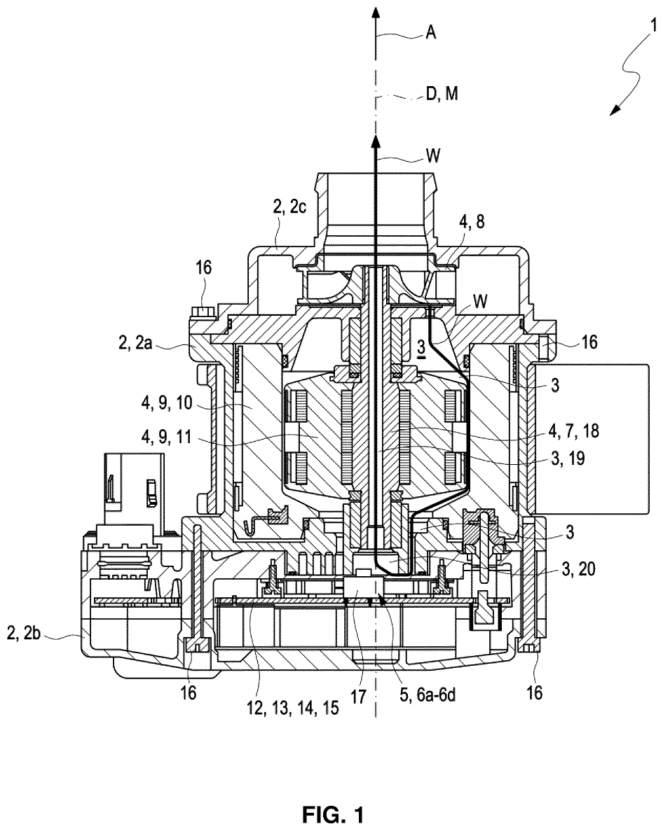

FIG. 1 shows an example of a pump device 1 in the form of a water pump in accordance with the invention, in a sectional view. The pump device 1 is used to transport cooling fluid W, in particular water, in particular cooling water. The pump device 1 comprises a housing 2, in which a fluid channel 3 is arranged through which the cooling fluid W to be pumped can flow. Furthermore, the pump device 1 comprises an electric drive unit 4, which in the example according to FIG. 1 is arranged partially in the fluid channel 3, for driving the cooling fluid W guided through the fluid channel 3. The drive unit 4 of the pump device 1 comprises a rotatable drive shaft 7 arranged in the fluid channel 3, on which a pump rotor 8 designed as an impeller is arranged in a rotationally fixed manner for pumping water as cooling fluid W in the fluid channel 3.

In addition, the pump device 1 of the embodiment according to FIG. 1 comprises an electrical sensor unit 5 which is arranged at least partially in the fluid channel 3 and which, in the example, comprises four sensors 6a, 6b, 6c, 6d for determining in each case a measured variable characterizing the cooling fluid W. In the example, a first 6a of the four sensors 6a-6d is a pressure sensor for determining the fluid pressure of the cooling fluid W guided through the fluid channel 3. This makes it possible to determine exactly the pressure at which the cooling fluid W is delivered by the pump device. A second 6b of the four sensors 6a-6d of the sensor unit 5 is a temperature sensor for determining the temperature of the cooling fluid W flowing through the fluid channel 3. This makes it possible to determine the temperature of the cooling fluid W flowing through the fluid channel 3 very accurately. This is particularly important if the cooling fluid W is to function as cooling water and thus absorb waste heat from the components to be cooled. A third 6c of the four sensors 6a-6d of the sensor unit 5 is a mass flow sensor for determining the mass flow of cooling fluid W through the fluid channel 3. In this way, the instantaneous flow rate of the cooling fluid pumped by the pump device can be precisely determined. A fourth 6d of the four sensors 6a-6d of the sensor unit 5 is an electrical conductivity sensor for determining the electrical conductivity of the cooling fluid W guided through the fluid channel 3. This also allows the electrical conductivity of the cooling fluid W to be precisely determined. Precise knowledge of the electrical conductivity of the cooling fluid W can prove particularly important if the fluid channel 3 is bounded by metal components, since the cooling fluid W could then cause an electrical short circuit if its electrical conductivity is too high.

The sensor unit 5 can be equipped with a sensor housing 17, in or on which the four sensors 6a-6d are arranged. Furthermore, the four sensors 6a-6d and the sensor housing 17 are designed as a single unit in this development program.

The drive unit 4 includes an electric machine 9 having a stator 10 and a rotor 11 for driving the drive shaft 7. The drive shaft 7 can be designed as a hollow shaft 18 with a hollow cylindrical geometry, as shown in FIG. 1, which surrounds a cylindrical cavity 19 on the circumference and is open on both sides in the axial direction. The cavity 19 forms part of the fluid channel 3. In this case, the sensor unit 5 with the sensors 6a-6d extends into the fluid channel 3 in the region of an axial extension 20 of the cavity 19. The stator 10 is fixed to the housing 2, while the rotor 11 is connected to the drive shaft 7 in a rotationally fixed manner, so that during operation of the pump device 1, a relative rotational movement takes place between the rotor 11 and the stator 10. The rotational movement of the rotor 11 takes place around an axis of rotation D that is identical to a center longitudinal axis M of the drive shaft 7. The center longitudinal axis M extends in an axial direction A. The drive shaft 7 can be rotatably arranged on the housing 2 or another component (not shown) of the pump device 1 that is stationary relative to the housing 2 by means of suitable bearing elements (not shown).

As FIG. 1 illustrates, the rotor 11 can be arranged in the fluid channel 3. The stator 10 can define the fluid channel 3 in the section of the fluid channel 3 in which the rotor 11 is arranged. Thus, the cooling fluid W flowing through the fluid channel 3 can cool both the stator 10 and the rotor 11.

Furthermore, the drive unit 4 includes a control/regulating device 12 for controlling the electric machine 9. The control/regulating device 12 includes an electrical circuit board 13 on which electrical and electronic components are arranged. These components can be, for example, capacitors, coils, resistors, switches, in particular semiconductor switches, as well as integrated circuits (not shown). The sensor unit 5 is electrically connected to the circuit board 13. Therefore, the electrical control of the sensor unit 5 and its sensors 6a-6d can be done directly via the printed circuit board 13 or with the help of the electrical/electronic components arranged on the printed circuit board 13. This means that the sensor unit 5 does not need to be wired separately to the outside; rather, the entire electrical application of the sensor unit can be carried out via the printed circuit board 13. In the example scenario, the sensor unit 5 is arranged directly on the printed circuit board 13. This eliminates the need for electrical connection lines between the printed circuit board and the sensor unit. The sensor unit 5 can optionally be electrically connected to the printed circuit board 13 by means of a suitable insulation-displacement connection and suitable plug connections, which simplifies any disassembly of the sensor unit 5 from the printed circuit board 13 that may be necessary.

In the example, the control/regulating device 12 includes an electrical power supply 14 for supplying the electrical machine 9 with electrical energy. In this case, the sensor unit 5 for supplying the at least one sensor 6 with electrical energy is electrically connected to this electrical power supply 14. Thus, the provision of an electrical power supply 14 and the provision of a separate electrical connection of the sensor unit 5 to such a power supply can be eliminated. Instead, the sensor unit 5 can be supplied with electrical energy via the electrical power supply of the control/regulating device 12. This considerably simplifies the electrical wiring of the electrical sensor unit 5, which also results in noticeable cost advantages. In addition, the control/regulating device 12 comprises a communication unit 15 for communicating with an external field bus (not shown), in particular a LIN or CAN bus of a motor vehicle. The sensor unit 5 for controlling the four sensors 6a-6d is electrically and also in a data-transmitting manner connected to this communication unit 15. This enables flexible control of the sensor unit 5 from the outside, in particular via the aforementioned field bus, without the need for a separate communication unit. Instead, communication unit 15 of the control/regulating device 12 can be used to control sensor unit 5.

In the example of FIG. 1, the housing 2 is designed in three parts with a main housing body 2a, in which the drive unit 4 is arranged, and with two opposing housing covers 2b, 2c, wherein the main housing body 2a can be arranged in a sandwich-like manner between the two housing covers 2b, 2c, as shown. The two housing covers 2b, 2c are each attached to the main body of the housing 2a using bolted connections 16. The sensor unit 5 and the circuit board 13 are each firmly attached to one of the two housing covers 2b, 2c. Thus, the sensor unit 5 can be pre-assembled on the first housing cover 2b during the assembly of the pump device 1. This makes it easier to assemble the pump device 1.

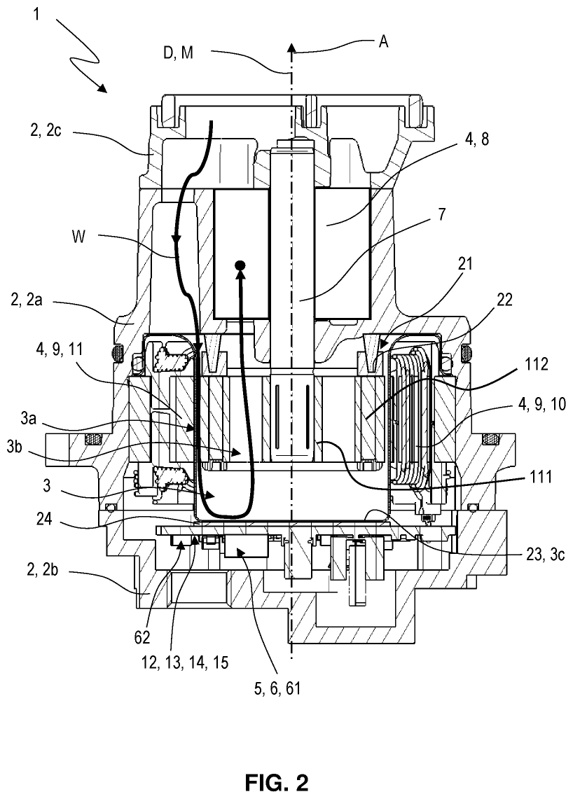

FIG. 2 shows an exemplary embodiment of a pump device 1 according to the second aspect of the invention in a schematic longitudinal section. Since the embodiment of FIG. 2 corresponds to the embodiment of FIG. 1 with respect to many features, reference is made to the above description with regard to corresponding features and supplemented below. The pump device 1 in FIG. 2 is used to pump oil as a cooling fluid W. The pump device 1 has a housing 2 with housing covers 2a, 2c and a housing main body 2b, in which a fluid channel 3 with several channel regions 3a, 3b between a stator 10 and a rotor 11 of an electric machine 9 and through an axial passage of the rotor 11 to a pump rotor 8. Pump rotor 8 and rotor 11 are connected to a drive shaft 7 in a torsion-proof manner. The pump device 1 is divided into a wet region and a dry region by a containment shell 23. The stator 10 and electrical/electronic components are located in the dry region. In the wet region, the fluid channel 3 and the rotor 11 are arranged.

The passage of the rotor 8 is formed radially between a holding section 111 and a magnet section 112. The holding section 111 is used to secure the rotor to the drive shaft 7. The magnet section 112 is permanently magnetic and contains permanent magnets.

A sealing device 21 is arranged axially between the pump rotor 8 and the rotor 11 to seal a region between the rotor 11 and the housing 2 through which cooling fluid W would otherwise flow. The sealing device 21 provides a sealing gap 22 through which only a negligible amount of cooling fluid W can penetrate. As a result, the cooling fluid W flowing through the rotor 11 is reliably directed to the pump rotor 8 without mixing significantly with the cooling fluid W from other channel regions.

Unlike the exemplary embodiment of FIG. 1, the drive shaft 7 is designed as a solid shaft. Instead of the cavity of a hollow shaft as part of the fluid channel, the rotor 11 is provided with the axial passage between the holding section 111 and a magnet section 112, through which cooling fluid W can flow. The passage is part of fluid channel 3. However, the invention also includes hollow shaft designs, such that the fluid channel can run through the hollow shaft to the pump rotor 8, in addition to running through the rotor 11.

In the exemplary embodiment according to FIG. 2, the pump device is designed as a gerotor pump. The pump rotor 8 is thus designed as a—in particular multi-stage—gerotor. The individual gerotor stages are not shown in the schematic representation. Multistage gerotor pumps are known and described, for example, in German patent application DE 10 2021 214 256 A1 or international patent application WO 00/42321 A1.

The flow path of the cooling fluid W through a channel region 3a between the rotor 11 and stator 10 is indicated by arrows. The pump device is essentially rotationally symmetrical in the region of the rotor 11 and stator 10, so that cooling fluid can naturally flow through the rotor 11 in both directions shown with respect to the axis of rotation D. The point drawn in the region of the pump rotor 8 illustrates the pumping of the cooling fluid W in the pump rotor 8 perpendicular to the axis of rotation of the pump rotor 8 from a suction side to a pressure side. Cooling fluid in the pump rotor is compressed from the suction side to the pressure side. The invention as a whole also includes, of course, embodiments in which the flow path of the cooling fluid is reversed, i.e., suction and pressure sides are reversed. In such embodiments, the cooling fluid flows from the pressure side through the rotor 11 or the drive shaft 7.

The containment shell 23 forms a fluid channel wall 3c at its bottom. When cooling fluid W is pumped through the fluid channel 3, fluid flows along the flow channel wall 3c along the flow path. This ensures good heat transfer from the cooling fluid to the fluid channel 3 and its fluid channel wall 3c.

The pump device 1 also includes a sensor unit 5. This is arranged on one side of a printed circuit board 13 of a control/regulating device 12 of the pump device 1, pointing away from the cooling channel 3. The sensor unit 5 has a sensor 6 designed as a temperature sensor 61. Another temperature sensor 62 is arranged at a distance on circuit board 13. The further temperature sensor 62 is preferably arranged in such a way that a heat flow transferred by heat conduction from the fluid channel 3 to the further temperature sensor 62 is at most 30% of a heat flow from the fluid channel 3 to the sensor 6 of the sensor unit. As a result, the other temperature sensor 62 mainly detects the self-heating of the printed circuit board 13, which correlates with the electrical power consumed. The temperature sensor 61 of the sensor unit 5, on the other hand, is used to determine the temperature of the cooling fluid W and is coupled to the fluid channel 5 in a heat-conducting manner for this purpose.

A gap filler is arranged as a heat-conducting layer 24 in contact with the fluid channel 3 and printed circuit board 13 between the printed circuit board 13 and the fluid channel 3 or the containment shell 23 or the fluid channel wall 3c. This heat-conducting layer 24 ensures good heat conduction between the fluid channel and the printed circuit board 13, wherein the sensor 6, as a temperature sensor, is coupled in a heat-conducting manner to the fluid channel 3 via the printed circuit board 13 and the heat-conducting layer 24.

The heat conducting layer 24 extends across the entire bottom of the containment shell. The circuit board 13 extends radially beyond the fluid channel wall 3c and the heat conducting layer 24. The fluid channel wall 3c, heat-conducting layer 24, and printed circuit board 13 are connected in a heat-conducting manner over the entire region in which they overlap.

A quality of the heat transfer of the cooling fluid to the fluid channel 5 or the sensor 6 is significantly improved if it is ensured that cooling fluid W flows continuously against the fluid channel wall 3c. Sensor 6 and sensor unit 5 and fluid channel 3 are therefore aligned with each other. Cooling fluid W, which is guided through channel region 3a towards the sensor unit 5, flows against the fluid channel wall 3c, transferring heat to the fluid channel wall 3c, and is deflected by it in such a way that the cooling fluid W is guided through channel region 3b away from the sensor unit 5 or sensor 6. Sensor 6 is placed at the same level as the point where the deflection occurs, so that the distance for heat transfer from fluid channel 3 to sensor 6 by heat conduction is as short as possible.

1. A pump device for a motor vehicle, comprising:
a housing, in which a fluid channel is arranged through which a cooling fluid to be conveyed can flow,
a drive unit for driving the cooling fluid guided through the fluid channel,
an electric sensor unit that comprises at least one sensor for determining at least one measured variable characterizing the cooling fluid wherein:
the sensor unit is arranged at least partially in the fluid channel and/or
the at least one sensor of the sensor unit is a temperature sensor that is arranged outside the fluid channel and is coupled in a heat-conducting manner to the fluid channel.

2. The pump device according to claim 1, wherein:
the drive unit comprises a rotatable drive shaft with a pump rotor for conveying the cooling fluid in the fluid channel and an electric machine with a stator and with a rotor for driving the drive shaft with the pump rotor,
the drive unit further comprises a control/regulating device for controlling the electric machine, wherein the control/regulating device has an electric printed circuit board on which at least one electric/electronic component is arranged, and
the sensor unit is electrically connected to the circuit board.

3. The pump device according to claim 2, wherein the sensor unit is arranged on the printed circuit board.

4. The pump device according to claim 2, wherein the pump device has a containment shell that separates in a fluid-tight manner a dry region, where the stator of the electric machine is arranged, from a wet region where the rotor of the electric machine is arranged and the fluid channel extends.

5. The pump device according to claim 1, wherein the fluid channel has two channel regions arranged one after the other along a flow path of the cooling fluid, the two channel regions including a first channel region structured and arranged to guide cooling fluid in a direction of the sensor unit and second channel region structured and arranged to guide cooling fluid that is guided in the direction of the sensor unit away from the sensor unit.

6. The pump device according to claim 2, wherein the rotor has an axial passage to the pump rotor and/or the pump device comprises a sealing device that is arranged axially between the pump rotor and the rotor for sealingly connecting the rotor and the housing, wherein the sealing device provides a sealing gap between the rotor and the housing, which is formed between a first sealing part connected to the rotor and a second sealing part connected to the housing.

7. The pump device according to claim 2, wherein a further temperature sensor for detecting a printed circuit board temperature is arranged on the printed circuit board, wherein the sensor unit and the further temperature sensor are spaced apart and interact such that, when the measured variable characterizing the cooling fluid is determined, an influence of self-heating of the printed circuit board on the measured variable can be taken into account by comparison with the printed circuit board temperature detected by the further temperature sensor.

8. The pump device according to claim 2, wherein:
the control/regulating device comprises an electrical power supply for supplying the electrical machine with electrical energy, and
the sensor unit for supplying the at least one sensor with electrical energy is electrically connected to the electrical power supply.

9. The pump device according to claim 2, wherein:
the control/regulating device comprises a communication unit for communicating with an external field bus, and
the sensor unit for controlling the at least one sensor is connected to the communication unit in an electrically and/or data-transmitting manner.

10. The pump device according to claim 1, wherein the sensor unit comprises at least two of the following sensors;
a pressure sensor for detecting the fluid pressure of the cooling fluid guided through the fluid channel,
a temperature sensor, for determining the fluid temperature of the cooling fluid conducted through the fluid channel,
a mass flow sensor for determining the mass flow of cooling fluid through the fluid channel, and/or
a mass flow sensor for determining the mass flow of cooling fluid through the fluid channel.

11. The pump device according to claim 1, wherein
the sensor unit comprises a sensor housing, in or on which the at least one sensor is arranged,
at least the at least one sensor and the sensor housing are structured as a unit.

12. The pump device according to claim 2, wherein
the drive shaft is hollow-cylindrical hollow shaft which surrounds a cylindrical cavity that forms part of the fluid channel,
the sensor unit is arranged in an axial extension of the cavity in the fluid channel.

13. A water pump comprising the pump device according to claim 1, wherein
the housing is at least two-part, with a main housing body, in which the drive unit is arranged, and at least one, housing cover which is detachably, fastened to the housing main body,
the sensor unit is firmly connected to the at least one housing cover.

14. A motor vehicle comprising
a cooling device with a cooling circuit for circulating cooling fluid,
a pump device arranged in the cooling circuit, for pumping the cooling fluid in the cooling circuit, the pump device including:
a housing, in which a fluid channel is arranged through which a cooling fluid to be conveyed can flow,
a drive unit for driving the cooling fluid guided through the fluid channel,
an electric sensor unit that comprises at least one sensor for determining at least one measured variable characterizing the cooling fluid,
wherein the sensor unit is arranged at least partially in the fluid channel, and/or the at least one sensor of the sensor unit is a temperature sensor that is arranged outside the fluid channel and is coupled in a heat-conducting manner to the fluid channel,
a drive train with components that generate waste heat, the components of the drive train are thermally coupled to the cooling circuit for the transfer of generated waste heat to the cooling fluid circulating in the cooling circuit.

15. A method for determining a measured variable, that characterizes a cooling fluid in a pump device the method comprising:
guiding the cooling fluid in a fluid channel towards a sensor unit,
transferring heat of the cooling fluid directed towards the sensor unit to the sensor unit by flowing into the fluid channel and via heat-conducting coupling of the fluid channel and sensor unit,
detecting, via a sensor of the sensor unit, the heat transferred to the sensor unit, and
directing the cooling fluid directed towards the sensor unit away from the sensor unit.

16. The method according to claim 15, where directing the cooling fluid away from the sensor unit includes diverting the cooling fluid along a flow path of the cooling fluid at a level of the sensor of the sensor unit from one channel region of the fluid channel to enter another channel region of the fluid channel.

17. The pump device according to claim 1, wherein the sensor unit projects into the fluid channel.

18. The pump device according to claim 1, wherein the temperature sensor is coupled in the heat-conducting manner to a fluid channel wall of the fluid channel.

19. The pump device according to claim 2, wherein the temperature sensor is coupled to the fluid channel in a heat-conducting manner via the printed circuit board.

20. The pump device according to claim 5, wherein the fluid channel is structured and arranged to divert the cooling fluid along the flow path at a level of the at least one sensor from the first channel region to enter the second channel region.
